(19) United States
(12) Patent Application Publication
(10) Pub. No.: US 2004/0029472 A1
(43) Pub. Date: Feb. 12, 2004

(54) Method and compound fabric with latent heat effect

(75) Inventor: Yen-Shyi Lin, Tu-Chen City (TW)

Correspondence Address: BACON & THOMAS, 625 Slaters Lane 4th Floor, Alexandria, VA, 22314, US

(73) Assignee: CHINA TEXTILE INSTITUTE, Tu-Chen City (TW)

(21) Appl. No.: 10/212,204

(22) Filed: Aug. 6, 2002

(51) Int. Cl. B32B 27/04

(52) U.S. Cl. 442/131; 442/133; 428/320.2; 427/384

(57) ABSTRACT

The present invention provides a method and compound fabric for latent heat effect which means a compound fabric capable of undergoing heat storage (release) material for microcapsules with waterborne polyurethane shell which use interfacial condensation polymerization by waterborne polyurethane thereof, such as alkyl alkyrate (alkyric acid alkyl ester) for temperature in the range of 0° C. to 80° C. The fabric is selected from the group of consisting of woven, non-woven and structure of woven, and the present invention provides method to coat waterborne polyurethane shell microcapsules of heat storage (release) material for compound fabric

### FIELD OF THE INVENTION

The present invention of a method and compound fabric for latent heat effect which discloses a compound fabric capable of undergoing heat storage (release) material using solid/liquid transition in the range of 0° C. to 80° C. for microcapsules with alkyl alkyrate (alkyric acid alkyl ester) that the carbon atom alkyl is from 1 to 26 and the carbon atom alkyrate is from 1 to 12 by using interfacial condensation polymerization. Because of phase translation from solid to liquid having leak problem, fabrics obtain enhanced thermal properties by coating the fibers with encapsulated the phase change material microcapsules. Thus, the microcapsules add waterborne polymer binder to compound fabric.

### BACKGROUND OF THE INVENTION

At the phase change temperature, a characteristic of phase change material during solid/liquid transition cycle is to absorb and release a quantity of latent heat.

In general, the material can be used as a barrier to heat, since a quantity of latent heat must be absorbed by the phase change material before its temperature can rise. Similarly, the phase change material may be used a barrier to cold, as a quantity of latent heat must be removed from the phase change material before its temperature can begin to drop.

The important prior art patent of method of heat storage (release) material for microcapsules, which comprise:

BASF Aktiengesellschaft, U.S. Pat. No. 6,200,681, Application of microcapsules as latent heat accumulators, which discloses the latent heat storage media for microcapsules with C₁-C₂₄-alkyl esters of acrylic and/or methacrylic acid by free-radical polymerization for the solid/liquid phase transition from −20 to 120° C. The latent heat storage media is selected from the group consisting of alkyl or aromatic hydrocarbon compounds, saturated or unsaturated C₆-C₃₀ fatty acids, fatty alcohols, C₆-C₃₀fatty amines and esters. The esters is selected from the group consisting of C₁-C₁₀-alkyl esters of fatty acids, propyl palmitate, methyl stearate, methyl palmitate, methyl cinnamate, natural and synthetic waxes and halogenated hydrocarbons. Thus, it can obtain a fact of commercial value of the latent heat storage media for microcapsules, which is more useful.

Mitsubishi Paper Mills Limited, U.S. Pat. No. 5,456,825, Microcapsules for heat-storing material, which discloses the latent heat storage media for microcapsules with melamine-formaldehyde surfactant by in-suit polymerization for the solid/liquid phase transition from 20° C. to 110° C. The carbon atom of alkyl hydrocarbons is greater than 10. The ester is selected from the group consisting of alkyl myristate, allkyl palmitate, alkyl stearate, high-melting fatty acid, high-melting fatty alcohol, high-melting fatty amine and mixtures thereof. Thus, it can obtain another face of commercial value of the latent heat storage media for microcapsules in a greater area.

Union Carbide Corporation, U.S. Pat. No. 4,708,812, Encapsulation of phase change materials, which discloses polyurethane-urea encapsulated phase change material microcapsules with phase change material, surfactant, solvent and polyamines by interfacial condensation prepolymerization. The phase change material is selected from the group consisting of crystalline polymers, naphthalene, salt hydrate and crystalline paraffin hydrocarbons (Paravan 4450 , mp=71° C. Slack Wax 3663 mp=60° C.). Thus, it can be very useful for the latent heat storage media for microcapsules.

The important prior art patent of coating method fabric with heat storage (release) material of microcapsules for compound fabric, which comprise:

Triangle Research and Development Corporation, U.S. Pat. No. 5,366,801, fabric with reversible enhanced thermal properties, which discloses The fabric and fiber coat with microcapsules encapsulated paraffin hydrocarbon for solid/liquid phase transition from −5.5° C. to 61.4° C. by Polymeric binder. The Polymeric binder is selected from the group consisting of polyurethane, nitrile rubber, chloroprene rubber, polyvinyl alcohol, silicone, ethylene/vinyl acetate copolymer, acrylic and adding Plastic crystals. But, Outlast Technologies, Inc., U.S. Pat. No. 6,207,738, Fabric coating composition containing energy absorbing phase change material, which discloses the polymeric binder of compound fabric for microcapsules use of solvent based gravure printing techniques which proved unsuccessful because the solvent systems damaged the microcapsules, and higher temperature thermoplastic gravure printing techniques also proved unsatisfactory for use with microcapsules by higher temperature of 325° F. (162° C.). Although lower temperature thermoplastic gravure printing techniques avoided significant damage to the microcapsules, the resulting coating was found lacking in washability and durability. the thermoplastic spray technique encapsulate microcapsules of phase change materials have proved unsatisfactory, and then the thermoplastic extrusion techniques create a film of continuous web which has uniformly distributed problem. The present invention of a method and compound fabric for latent heat effect which discloses a compound fabric capable of undergoing heat storage (release) material using temperature in the range of 0° C. to 80° C. for microcapsules with alkyl alkyrate (alkyric acid alkyl ester) that the carbon atom alkyl is from 1 to 26 and the carbon atom alkyrate is from 1 to 12 by using interfacial condensation polymerization. However, the microcapsules add waterborne polymer binder to compound fabric. The waterborne polymer binder is selected from the group consisting of waterborne polyurethane, waterborne acrylic, polyvinyl alcohol, polyvinyl acetate and mixtures thereof. Because of no solvent for coating, the present invention provides commercial compound fabric by waterborne polymer binder. Thus, it is no solvent problem and obtains the washability and durability.

### OBJECT OF THIS INVENTION

Therefore, the present invention provides method and compound fabric with latent heat effect by microcapsules of waterborne polyurethane shell.

The main object of the present invention is to provide flexible and no fragile microcapsules.

Another object of the present invention is to provide a no residual formaldehyde problem for compound fabric.

The other object of the present invention is to provide a coating method for compound fabric.

### SUMMARY OF THE INVENTION

A method of compound fabric with latent heat effect which means a compound fabric capable of undergoing heat storage (release) material for microcapsules with waterborne polyurethane shell which use interfacial condensation polymerization by waterborne polyurethane thereof; said heat storage (release) material for microcapsules with waterborne polyurethane shell being mixed from the group consisting of water, waterborne polyurethane, heat storage (release) material, and adding a curing agent and a solvent for temperature in the range of 60° C. to 90° C. by high speed mixing and then ridding of solvent, said microcapsules adding waterborne polymer binder to compound fabric.

### BRIEF DESCRIPTION OF THE DRAWINGS

The present invention will be better understood from the following detailed description of preferred embodiments of the invention, taken in conjunction with the accompanying flow diagram, in which

FIG. 1 is a flow diagram showing the methodology for providing heat storage (release) material for microcapsules with waterborne polyurethane shell.

### DESCRIPTION OF THE PREFERRED EMBODIMENTS

The following descriptions of the preferred embodiments are provided to understand the features and the structures of the present invention.

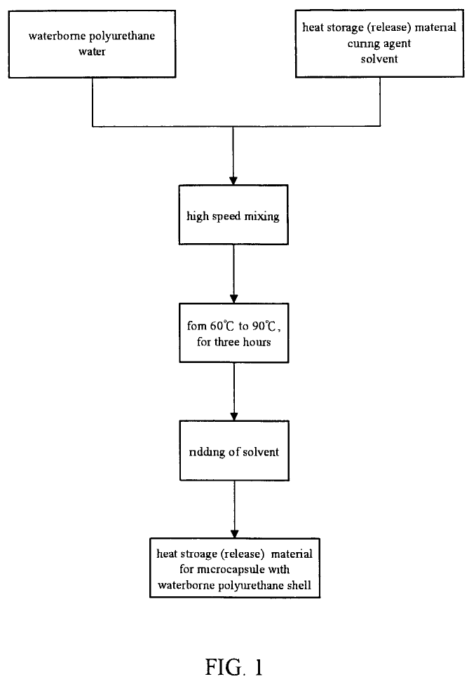

The present invention provides a method of compound fabric with latent heat effect which means a compound fabric capable of undergoing heat storage (release) material for microcapsules with waterborne polyurethane shell which use interfacial condensation polymerization by waterborne polyurethane thereof. Please refer to the FIG. 1, it is a flow diagram showing the methodology for providing heat storage (release) material for microcapsules with waterborne polyurethane shell. The said heat storage (release) material for microcapsules with waterborne polyurethane shell is mixed from the group consisting of water, waterborne polyurethane, heat storage (release) material, and adding a curing agent and a solvent by mixing to temperature in the range of 60° C. to 90° C. for three hours and ridding of solvent.

The said heat storage (release) material for microcapsules with waterborne polyurethane shell, wherein said microcapsules comprises a material of alkyl alkyrate (alkyric acid alkyl ester) The carbon atom alkyl of said alkyl alkyrate (alkyric acid alkyl ester)is from 1 to 26 and the carbon atom alkyrate of said alkyl alkyrate (alkyric acid alkyl ester)is from 1 to 12 . Thus, the said alkyl alkyrate (alkyric acid alkyl ester) is being substituted for paraffin hydrocarbon and capable of undergoing heat storage (release) material for the solid/liquid transition from 0° C. to 80° C. The said waterborne polyurethane is selected from the group consisting of 2,2-Bis(hydroxymethyl) propionic acidmethylamine, sodium sulfite salt and mixtures thereof.

The present invention is illustrated in detail with the following examples, which should not be construed as limiting the scope of the invention.

### EXAMPLE 1

This example synthesize heat storage (release) material for microcapsules with waterborne polyurethane shell

| Weight | Name | Content |
|---|---|---|
| 76 g of | Water | |
| water phase | | |
| 24 g of | waterborne | 40% solid of waterborne polyurethane, |
| water phase | polyurethane | and being selected from the group |
| | | consisting of 2,2-Bis(hydroxymethyl) |
| | | propionic acid - triethylamine, sodium |
| | | sulfite salt and mixtures thereof. |
| 50 g of oil | dodecanyl | industry grade or synthesis |
| phase | formate to | |
| | stearyl formate | |
| 30 g of oil | solvent | toluene, benzene or ethyl acetate |
| phase | | |
| 4.5 g of oil | curing gent | melamine curing agent or isocyanate |
| phase | | curing agent |

Please refer to Example 1, In water phase which add 24 g of waterborne polyurethane and 76 g of water heat in the range of 40° C. to 60° C., and then pour into the 40° C. to 60° C. oil phase mixtures of dodecanyl formate to stearyl formate, curing agent and solvent. The resulting mixed solution use homomixer to high speed mix by 4500 rpm and then heat in the range of 60° C. to 90° C. for three hours, and vapor solvent to obtain 40% solid of waterborne polyurethane by rotary. Therefore, the microcapsules with waterborne polyurethane shell carries out the particle size in the range of 1 μm to 5 μm.

### EXAMPLE 2

This example synthesize heat storage (release) material for microcapsules with waterborne polyurethane shell

| Weight | Name | Content |
|---|---|---|
| 150 g of water | water | |
| phase | | |
| 24 g of water | waterborne | 40% solid of waterborne polyurethane, |
| phase | polyurethane | and being selected from the group |
| | | consisting of 2,2-Bis(hydroxymethyl) |
| | | propionic acid - triethylamine, sodium |
| | | sulfite salt and mixtures thereof. |
| 50 g of oil | butyl dodecate | industry grade or synthesis |
| phase | to hexyl | |
| | dodecate | |
| 30 g of oil | solvent | toluene, benzene or ethyl acetate |
| phase | | |
| 4.5 g of oil | curing agent | melamine curing agent or isocyanate |
| phase | | curing agent |

Please refer to Example 2, In water phase which add 24 g of waterborne polyurethane and 150 g of water heat in the range of 40° C. to 60° C., and then pour into the 40° C. to 60° C. oil phase mixtures of butyl dodecate to hexyl dodecate, curing agent and solvent. The resulting mixed solution use homomixer to high speed mix by 6500 rpm and then heat in the range of 60° C. to 90° C. for three hours, and then vapor solvent to obtain a 30% solid of waterborne polyurethane by rotary. Therefore, the microcapsules with waterborne polyurethane shell carries out the particle size in the range of 0.5 m to 0.2 m.

The said microcapsules add waterborne polymer binder to compound fabric is illustrated in detail with the following example, which should not be construed as limiting the scope of the invention.

### EXAMPLE 3

it illustrate the coating method with water solution of microcapsules with waterborne polyurethane shell and waterborne Polymeric binder for compound fabric.

| Item | Content | proportion |
|---|---|---|
| water solution of | water solution of heat | from 20% to 80% |
| microcapsules with | storage (release) | |
| waterborne | material for microcapsules | |
| polyurethane shell | with waterborne | |
| | polyurethane shell. (ester | |
| | chemical composition or | |
| | mixtures thereof) | |
| waterborne | curing agent and | from 80% to 20 % |
| Polymeric binder | waterborne Polymeric | |
| | binder. (such as: | |
| | waterborne polyurethane, | |
| | acrylic ester, polyvinyl | |
| | alcohol, polyvinyl acetate, | |
| | or mixtures thereof) | |

The coating technique, for said microcapsules add waterborne polymer binder to compound fabric, which is selected from the group consisting of gravure printing technique, higher temperature thermoplastic gravure printing technique, lower temperature thermoplastic gravure printing technique, thermoplastic spray technique, and thermoplastic extrusion technique.

The present invention does not only possess a better practicality, neither only a conception based on familiarity of utilization, it is non-obviousness and useful, which comprise:

1. The flexible and no-fragile microcapsules with waterborne polyurethane shell which use interfacial condensation polymerization by waterborne polyurethane thereof, when produce to coated fabrics.

2. The microcapsules with waterborne polyurethane shell does not use formaldehyde. Thus, there is not residual formaldehyde problem for compound fabric.

3. The heat storage (release) material for microcapsules with waterborne polyurethane shell, wherein said microcapsules comprises a material of alkyl alkyrate (alkyric acid alkyl ester). The carbon atom alkyl of said alkyl alkyrate (alkyric acid alkyl ester) is from 1 to 26 and the carbon atom alkyrate of said alkyl alkyrate (alkyric acid alkyl ester) is from 1 to 12. Thus, the said alkyl alkyrate (alkyric acid alkyl ester) is being substituted for paraffin hydrocarbon and capable of undergoing heat storage (release) material for the solid/liquid transition from 0° C. to 80° C.

4. Because of heat storage (release) material for microcapsules with waterborne polyurethane shell add waterborne polymer binder for compound fabric, thus, there are no harmful microcapsules.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

What is claimed is:

1. A method of compound fabric with latent heat effect which means a compound fabric capable of undergoing heat storage (release) material for microcapsules with waterborne polyurethane shell which use interfacial condensation polymerization by waterborne polyurethane thereof; said heat storage (release) material for microcapsules with waterborne polyurethane shell being mixed from the group consisting of water, waterborne polyurethane, heat storage (release) material, and adding a curing agent and a solvent by high speed mixing to temperature in the range of 60° C. to 90° C. and ridding of solvent, said microcapsules adding waterborne polymer binder to compound fabric.

2. A method of compound fabric with latent heat effect of claim 1, wherein said waterborne polyurethane comprises a 2,2-Bis (hydroxymethyl) propionic acid-triethylamine.

3. A method of compound fabric with latent heat effect of claim 1, wherein said waterborne polyurethane comprises a sodium sulfite salt.

4. A method of compound fabric with latent heat effect of claim 1, wherein said waterborne polyurethane comprises a mixtures of 2,2-Bis (hydroxymethyl) propionic acid-triethylamine and sodium sulfite salt.

5. A method of compound fabric with latent heat effect of claim 1, wherein said microcapsules comprises a material of alkyl alkyrate (alkyric acid alkyl ester).

6. A method of compound fabric with latent heat effect of claim 1, wherein said microcapsules comprises a material mixture of alkyl alkyrate (alkyric alkyl ester).

7. A method of compound fabric with latent heat effect of claim 5, wherein the carbon atom alkyl of said alkyl alkyrate (alkyric acid alkyl ester) is from 1 to 26 and the carbon atom alkyrate of said alkyl alkyrate (alkyric acid alkyl ester) is from 1 to 12.

8. A method of compound fabric with latent heat effect of claim 1, wherein said fabric is a woven.

9. A method of compound fabric with latent heat effect of claim 1, wherein said fabric is a non-woven.

10. A method of compound fabric with latent heat effect of claim 1, wherein said fabric is a structure of woven.

11. A method of compound fabric with latent heat effect of claim 1, wherein the weight percentage of said microcapsules with waterborne polyurethane shell is from 20% to 80% and the weight percentage of said waterborne polymeric binder is from 80% to 20%.

12. A method of compound fabric with latent heat effect of claim 1, wherein said waterborne polymeric binder is waterborne polyurethane.

13. A method of compound fabric with latent heat effect of claim 1, wherein said waterborne polymeric binder is an acrylic acid.

14. A method of compound fabric with latent heat effect of claim 1, wherein said waterborne polymeric binder is polyvinyl alcohol.

15. A method of compound fabric with latent heat effect of claim 1, wherein said waterborne polymeric binder is polyvinyl acetate.

16. A compound fabric with latent heat effect, comprising:
a compound fabric capable of undergoing heat storage (release) material for microcapsules with waterborne polyurethane shell.

17. A compound fabric with latent heat effect of claim 1, wherein fabric is selected from the group consisting of woven, non-woven and structure of woven.
